(19) United States
(12) Patent Application Publication
(10) Pub. No.: US 2006/0286537 A1
(43) Pub. Date: Dec. 21, 2006

(54) System and method for improving performance using practice tests

(76) Inventors: George V. Mandella, San Francisco, CA (US); John J. Sanchez, San Francisco, CA (US)

Correspondence Address: PERKINS COIE LLP, P.O. BOX 2168, MENLO PARK, CA, 94026, US

(21) Appl. No.: 11/444,061

(22) Filed: May 30, 2006

Related U.S. Application Data
(60) Provisional application No. 60/686,318, filed on May 31, 2005.

(51) Int. Cl. G09B 3/00

(52) U.S. Cl. 434/350

(57) ABSTRACT

A technique for improving test performance by simulating test conditions. A method according to the technique may include providing a question to an on-line tester, starting a print timer, and allowing the on-line tester to print the question if the print timer has not expired. The method may further include starting a test timer and allowing the on-line tester to submit an answer to the question if the test timer has not expired. The method may further include sending the answer to an on-line grader. A system according to the technique may include a question database, a testing engine, a grading engine, and a performance metric engine.

This application claims priority to U.S. Provisional Application No. 60/686,318 filed May 31, 2005, which is hereby incorporated by reference in its entirety.

### BACKGROUND

This application relates generally to computer applications and systems. In particular, the invention is related to practice tests.

There are many ways to improve performance in standardized and other tests. One well-known way is to take practice tests. Multiple-choice exams are the most common form of standardized test because, for example, they are objective and can be machine-graded.

Essay and written tests are more difficult to evaluate and typically require the use of a human grader. It may be possible to substitute an artificial intelligence (AI) grader for the human grader if AI becomes sufficiently sophisticated or if the format can be manipulated advantageously. One problem with essay-type tests may be the subjectivity involved in making a determination as to whether an answer is good or bad. One grader may evaluate an answer differently than another. This can lead to difficulty in determining whether the grader is sufficiently accurate to enable the test-taker to trust the results of a practice test.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for improving test performance using a testing service includes multiple facets. A facet of the technique may involve simulating test conditions such as by limiting time allowed to print test materials, limiting time allowed to take the test, and/or submission of answers to a grader. Since normal testing conditions typically involve tests printed on paper and little or no time to look at the test materials prior to starting, a method according to the technique may include providing a question to an on-line tester, starting a print timer, and allowing the on-line tester to print the question if the print timer has not expired. It may also be desirable to start the test before the printed test can be studied. So, the method may further include starting a test timer and allowing the on-line tester to submit an answer to the question if the test timer has not expired. The method may further include sending the answer to an on-line grader.

Another facet of the technique may involve ensuring reasonable accuracy in grading. For example, a method may include providing an ungraded exam from a database of ungraded exams to one of a plurality of on-line graders, displaying for the on-line grader an answer to a question of the ungraded exam, displaying for the on-line grader a scorecard associated with the question, allowing the on-line grader to mark up the scorecard, and sending the marked up scorecard to an on-line tester associated with the answer.

Another facet of the technique may involve weighting testing criteria appropriately. For example, a method may include weighting a plurality of objective valuation categories relative to one another according to estimated values for each of the objective valuation categories, receiving a grader scorecard having the plurality of objective valuation categories represented thereon, wherein the grader scorecard has been marked up according to an objective evaluation of an answer to a test question, calculating, using the marked-up scorecard, statistics associated with the answer and one or more of the objective valuation categories, and presenting a performance metric that incorporates the statistics.

A system according to the technique may include a question database, a testing engine, a grading engine, and a performance metric engine. The question database may have a plurality of questions for provisioning to potential test takers. The testing engine may be effective to provide a question to a test-taker, and accept an answer to the question from the test-taker. The grading engine may be effective to provide the answer to a grader, provide a scorecard having a plurality of objective valuation categories represented thereon, and receive the marked-up scorecard from the grader after the grader marks up the scorecard based upon an objective evaluation of the answer. The performance metric engine may be effective to calculate statistics associated with the answer and the objective valuation categories, wherein the statistics are effective to objectively estimate performance with respect to the answer by the test taker.

In addition to the exemplary aspects and embodiments described above, further aspects and embodiments, including combinations and subcombinations thereof, will become apparent by reference to the drawings and by study of the following description.

### BRIEF DESCRIPTION OF THE DRAWINGS

Embodiments of the invention are illustrated in the figures by way of non-limiting examples.

FIG. 1 depicts a flowchart of an example of a method for provisioning a test-taker with a test question.

FIG. 2 depicts a flowchart of an example of a method for provisioning a grader with an ungraded answer to a test question.

FIG. 3 depicts a flowchart of an example of a method for generating statistics associated with a test question.

FIG. 4 depicts a system appropriate for the implementation of the methods described with reference to FIGS. 1-3.

FIGS. 5, 6, and 7 depict examples of screen shots and data that may be associated with exemplary methods and systems.

FIGS. 8A and 8B depict a conceptual view of a system on which one or more of the described embodiments may be implemented.

### DETAILED DESCRIPTION

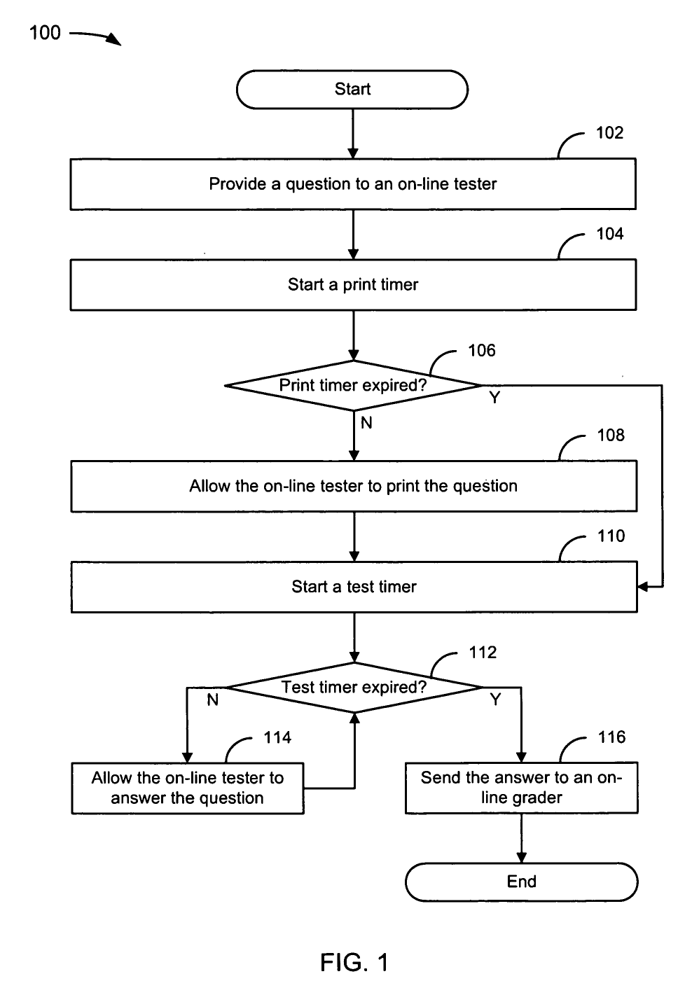

A technique for evaluating performance involves, in a non-limiting embodiment, provisioning a test-taker with a question, provisioning a grader with the ungraded answer, and provisioning a performance metric engine with the graded answer and/or data related thereto. Non-limiting examples of these are provided in FIGS. 1-3, respectively.

FIG. 1 depicts a flowchart 100 of an example of a method for provisioning a test-taker with a test question. This method and other methods are depicted as serially arranged modules. However, modules of the methods may be reordered, or arranged for parallel execution as appropriate.

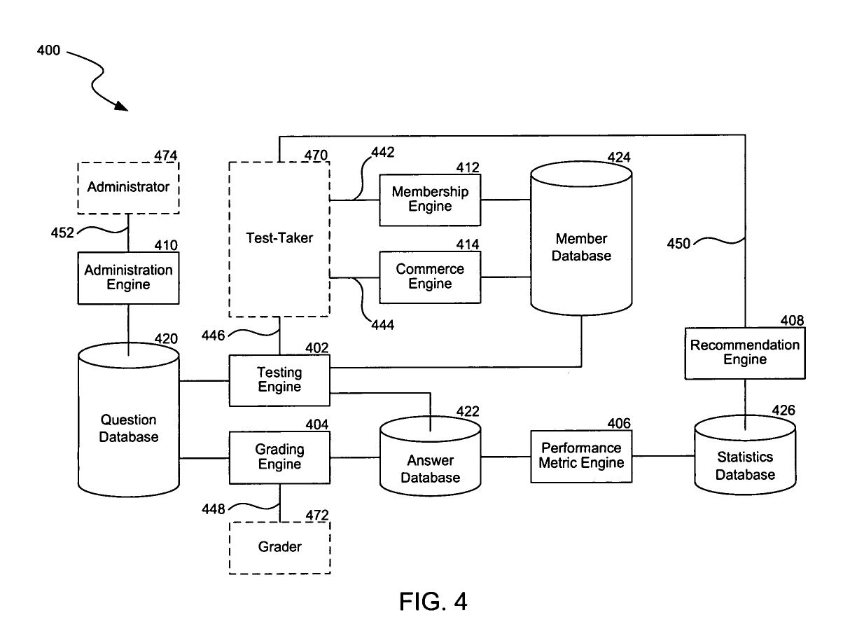

In the example of FIG. 1, the flowchart 100 starts at module 102 where a question is provided to an on-line tester. “On-line,” as used herein, may mean that the tester has access to a server over a Local Area Network (LAN), Wide Area Network (WAN), the Internet, or some other network. Exemplary system components are described later with reference to FIG. 4. In a non-limiting embodiment, a mechanism exists to make sure that the on-line tester does not receive the same question twice.

In the example of FIG. 1, the flowchart 100 continues at module 104 where a print timer is started. As used herein, a print timer is a clock, register, or some other mechanism for keeping track of the passage of time. The print timer may be located on a machine that is local to the test-taker, a machine that is associated with the server, or on some other machine.

In the example of FIG. 1, the flowchart 100 continues at decision point 106 wherein it is determined whether the print timer has expired. In a non-limiting embodiment, the print timer expires after a period of time associated with actual test conditions has passed. If it is determined that the print timer has not expired (106-N), then, in the example of FIG. 1, the flowchart 100 continues at module 108 where the on-line tester is allowed to print the question. In a non-limiting embodiment, the test-taker can use the printed question while answering the question. This may or may not more accurately simulate actual test-taking conditions if the question is being provided as part of a practice test. After the question has been printed, the test-taker may have the option of canceling the print timer so as to proceed to a next stage, such as, by way of example but not limitation, a question-answering stage. Alternatively, the test-taker may be provided with the opportunity to wait for the print timer to expire. Alternatively, the test-taker must simply wait for the print timer to expire before proceeding. In any case, in the example of FIG. 1, the flowchart continues to module 110 from module 108.

If, on the other hand, it is determined that the print timer has expired (106-Y), then, in the example of FIG. 1, the flowchart 100 continues at module 110 where a test timer is started. The test timer is similar to the print timer in that any time-keeping mechanism would be sufficient and that the test timer may be located on the machine associated with the test-taker, or on some other machine.

In the example of FIG. 1, the flowchart 100 continues at decision point 112 where it is determined whether the test timer has expired. If it is determined that the test timer has not expired (112-N), then, in the example of FIG. 1, the flowchart 100 continues at module 114 where the on-line tester is allowed to answer the question. After the question has been answered, the test-taker may have the option of canceling the test timer so as to proceed to a next stage, such as, by way of example but not limitation, the end of the test. Alternatively, the test-taker may be provided with the opportunity to wait for the test timer to expire. Alternatively, the test-taker must simply wait for the test timer to expire before proceeding. In any case, in the example of FIG. 1, the flowchart continues to loop between decision point 112 and module 114 until the test timer expires.

When it is determined that the test timer has expired (112-Y), then, in the example of FIG. 1, the flowchart 100 ends at module 116 where the answer is sent to an on-line grader. The on-line grader may or may not be on-line when the test ends. By way of example but not limitation, the answer may first be sent to an answer database and later assigned to the on-line grader when the on-line grader becomes available, when the on-line grader selects the answer from the database, or for some other reason or at some arbitrary, predetermined, and/or convenient time.

In an alternative, multiple questions may be provided in a manner that is similar to that described with reference to FIG. 1. For example, multiple questions may be provided to a test-taker and the test-taker may print out the multiple questions so long as a print timer has not expired. As another example, a test-taker may switch between questions and answer the questions in any order desired so long as the test timer has not expired. In another alternative, the flowchart 100 could repeat several times from start to finish, which may or may not simulate actual test-taking conditions during a practice test. In another alternative, the test-taker may practice one question at a time.

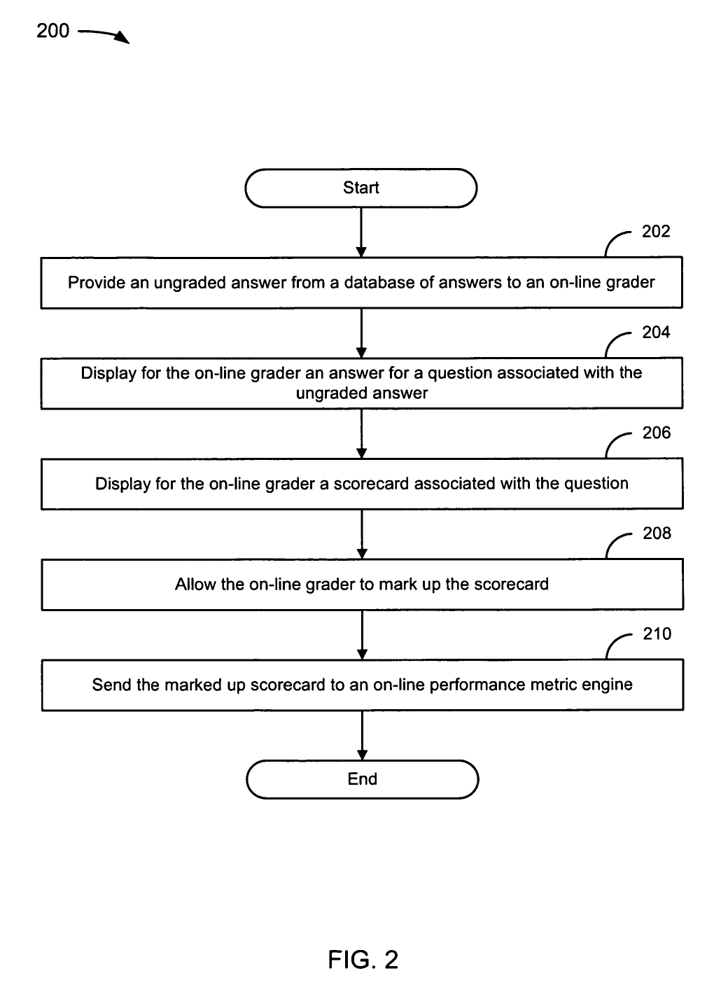

FIG. 2 depicts a flowchart 200 of an example of a method for provisioning a grader with an ungraded answer to a test question. In a non-limiting embodiment, answers may be assigned to graders based on topic/subject matter expertise or some other designation for purposes of efficiency and workflow distribution. In another non-limiting embodiment, ungraded answers may be served according to a first-in first-out (FIFO) or “aging” principle wherein tests that have been ungraded the longest will be served first.

In the example of FIG. 2, the flowchart 200 starts at module 202 where an ungraded answer from a database of answers is provided to an on-line grader. The answer may be provided by, by way of example but not limitation, assigning the answer to the grader, allowing the grader to request the answer, allowing the grader to request an answer and then be assigned the answer in response to the request, or in response to some other stimulus or for some other reason.

In the example of FIG. 2, the flowchart 200 continues at module 204 where an answer to a question associated with the ungraded answer is displayed for the on-line grader. In this example, the on-line grader may derive some benefit from seeing a model answer to the question. In other embodiments, an answer may or may not be displayed for the on-line grader.

In the example of FIG. 2, the flowchart 200 continues at module 206 where a scorecard associated with the question is displayed for the on-line grader. In a non-limiting embodiment, the scorecard includes objective valuation categories that may help the grader evaluate the answer objectively. In a non-limiting embodiment, the scorecard includes a feature called the “advisor” that assigns default/average numerical weighting to the constituent issues to assist in the assignment of numerical scores for issue, rule, analysis, conclusion (IRAC) and then averages these together to derive a recommended overall score. These scores may be overridden at the grader's option prior to submission.

A non-limiting embodiment includes an open-source What You See Is What You Get (WYSIWYG) editor called FCKeditor (http://www.fckeditor.net) that allows the grader to add inline commenting/markup to a submitted answer that allows formatting features such as bold, underline, italic, strikethrough, font color, etc. The tester's original answer will be preserved intact, and a copy of this “annotated” answer will also be saved and made available for the tester's review.

Especially in the case of essay questions, the objective valuation categories must be carefully designated so as to allow the grader to decide whether the objective valuation category is objectively met. By way of example but not limitation, there could be four objective evaluation categories, which may be summarized as 1) issue, 2) rule, 3) analysis, and 4) conclusion. To objectively meet the “issue” objective evaluation category, an answer must, for example, include mention of a pre-determined issue. To objectively meet the “rule” objective evaluation category, an answer must, for example, correctly state a rule associated with the issue. To objectively meet the “analysis” objective evaluation category, an answer must, for example, apply facts related to the issue to the rule in a logical manner. To objectively meet the “conclusion” objective evaluation category, an answer must, for example, draw a conclusion from the analysis.

In some cases, objective evaluation categories must be construed consistently. For example, if a question has an associated “rule” objective valuation category of “Burglary is defined as the breaking and entering into the dwelling place of another at night with the intent to commit a felony therein,” then it must be determined whether the rule is stated correctly if one of the elements, e.g., “at night” is missing from the answer. In a non-limiting embodiment, each designated element of a rule must be stated for the objective evaluation category to be met. In another non-limiting embodiment, a majority of designated elements of a rule must be stated. In another non-limiting embodiment, one element of a rule must be stated. Other objective evaluation categories are comparable.

A non-limiting example of a subjective evaluation category is “technique.” This is subjective because the grader must consider a large number of parameters, such as punctuation, organization, passive voice, etc. in determining whether the category is met. Different graders may have different views regarding technique. However, if technique was simply related to whether an answer had a period at the end, the evaluation category could be considered objective because a grader could simply look for the period.

In the example of FIG. 2, the flowchart 200 continues at module 208 where the on-line grader is allowed to mark up the scorecard. As used herein, “allowed” means that one is given an opportunity to accomplish some task. Thus, in a non-limiting embodiment, the on-line grader is given the opportunity to mark up the scorecard by, by way of example but not limitation, rendering a web page with the scorecard provided therein to the on-line grader. Alternatively, the scorecard could be provided by email or some other transmission means.

In a non-limiting embodiment, the scorecard has multiple checkboxes. Each checkbox is associated with an instance of an objective valuation category. In alternative embodiments, the scorecard could include other structures, displays, or elements that facilitate marking when an instance of an objective valuation category has been met. For the purposes of illustration only, the term “checkbox” is used to describe any of these various implementations.

In a non-limiting embodiment, multiple instances of an objective valuation category exist for each answer. For example, a question may raise the issue of whether a subject of the question has committed murder and/or arson. If the issue is raised, then the scorecard may contain two or more checkboxes for the “issue” objective valuation category (e.g., one for each instance). In a non-limiting embodiment, each instance of an “issue” objective valuation category has associated instances of “rule,” “analysis,” and “conclusion” object valuation categories.

In the example of FIG. 2, the flowchart 200 ends at module 210 where the marked up scorecard is sent to an on-line performance metric engine. In a non-limiting embodiment, the grader may decide when an answer has been graded and submit the graded answer. The graded answer may be stored in an answer database. In a non-limiting embodiment, the graded answer remains associated with the test-taker. In an alternative embodiment, the grader may send the scorecard directly to a test-taker associated with the answer.

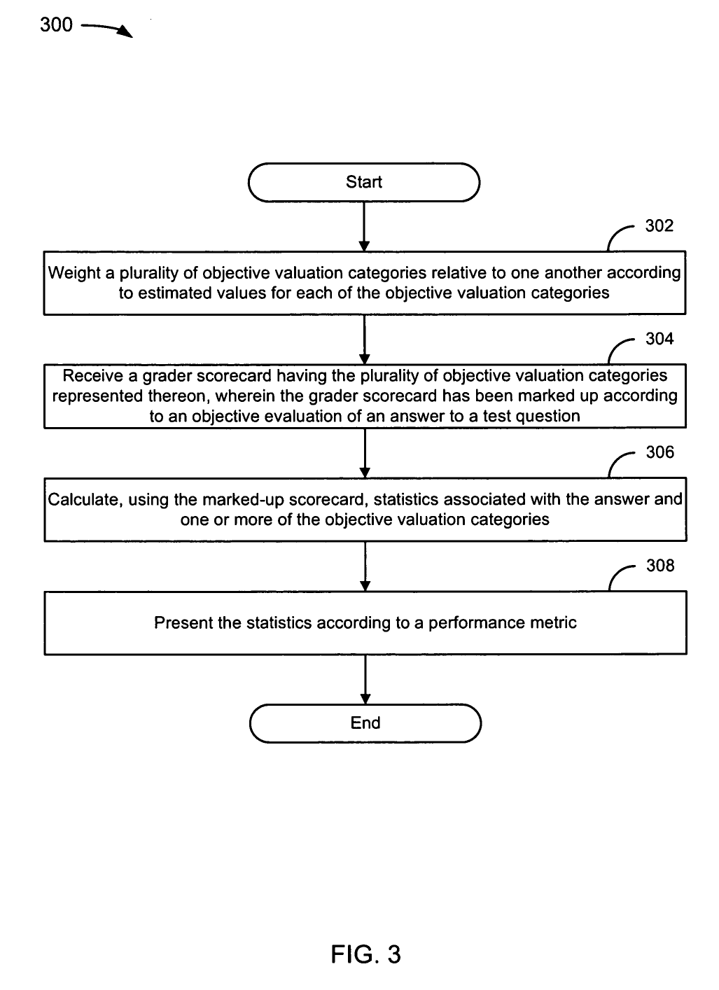

FIG. 3 depicts a flowchart 300 of an example of a method for generating statistics associated with a test question. In the example of FIG. 3, the flowchart 300 starts at module 302 where a plurality of objective valuation categories are weighted relative to one another according to estimated values for each of the objective valuation categories. In a non-limiting embodiment, the objective valuation categories may or may not be weighted before the objective valuation categories are provided to a grader on a scorecard. Advantageously, since the objective valuation categories are objective, it makes little difference whether the grader is aware of a difference in weight between the objective valuation categories. In a non-limiting embodiment, the weights of some or all objective valuation categories may or may not be the same.

In a non-limiting embodiment that includes “issue,” “rule,” “analysis,” and “conclusion” objective evaluation categories, it may be determined that “issue,” “rule,” and “analysis” have a weight of “2” each, while “conclusion,” being less important, has a weight of “1.” Of course, other weights may be used. Moreover, the grading of a test may change over time such that an estimated weight, while a good estimate for a first period of time, becomes a gradually poorer estimate. In such a case, it may or may not be desirable to change the weights to match the changing grading standards of a test for which a test-taker is practicing.

In a non-limiting embodiment, it may be determined that a first objective evaluation category must be satisfied in order to count a second objective evaluation category for a given statistic. For example, in a non-limiting embodiment that includes “issue” and “conclusion,” it may be determined that a conclusion is not worth anything if the issue is not identified. Accordingly, in this example, a final evaluation may be 0 if an issue is not identified, 1 if the issue is identified but there is no conclusion, and 2 if the issue is identified and there is a conclusion. (These numbers are provided for illustrative purposes only.)

In the example of FIG. 3, the flowchart 300 continues at module 304 where a grader scorecard having a plurality of objective valuation categories represented thereon is received. In the example of FIG. 3, the grader scorecard is marked up according to an objective evaluation of an answer to a test question. In a non-limiting embodiment, the scorecard may or may not also include marks associated with a subjective evaluation or notes from the grader.

In the example of FIG. 3, the flowchart 300 continues at module 306 where, using the marked-up scorecard, statistics associated with the answer and one or more of the objective valuation categories are calculated. In various embodiments, these statistics may be used for various purposes. By way of example but not limitation, the statistics may be provided to a test taker to show how well the test taker performed for a given question. However, the statistics may not be of great value in cases where many instances of objective valuation categories result in too much information to a test taker. Accordingly, in a non-limiting embodiment, it may be valuable to use a performance metric.

In the example of FIG. 3, the flowchart 300 continues at module 308 where the statistics are presented according to a performance metric. In a non-limiting embodiment, the statistics may be segmented by question characteristics. For instance, a test taker may wish to gauge performance on questions related to, by way of example but not limitation, torts or criminal law. Question characteristics may be designated in any manner that is desired by the administrator, manager, designer, test-taker or other person. Some non-limiting examples of question characteristics are areas of law, educational or technical disciplines, brand names, or any of a wide variety of other categories.

In another non-limiting embodiment, the performance metric may be capable of displaying performance over time, or performance over time with respect to questions having a given question characteristic. In another non-limiting embodiment, it may be desirable to compare statistics associated with different test-takers, or test-takers having certain characteristics. For example, one may wish to know performance based upon the age of various test-takers or based upon the school attended by various test-takers.

FIG. 4 depicts a system 400 appropriate for the implementation of the methods described with reference to FIGS. 1-3. The system 400 includes a testing engine 402, a grading engine 404, a performance metric engine 406, a recommendation engine 408, an administration engine 410, a membership engine 412, a commerce engine 414, a question database 420, an answer database 422, a member database 424, and a statistics database 426. For the purposes of illustration only, the system 400 may be associated with a test-taker 430, a grader 432, and an administrator 434. The engines 402-414 and databases 420-426 may be stored on a server or in the non-volatile or volatile memory of a computer local or remote with respect to the server.

In the example of FIG. 4, the system 400 may be implemented on a single machine or multiple machines. The test-taker 430 may be referred to as a client computer, and may be located locally or remotely with respect to the components of the system 400. For example, the test taker 430 may include a web browser with web pages that are rendered by a server associated with the components of system 400. The grader 432 may be referred to as a client computer, and may be located locally or remotely with respect to the components of the system 400. The administrator 434 may be referred to as a client computer, and is likely to be located locally with respect to the components of the system 400, though this is not required.

In operation, in a non-limiting embodiment, the membership engine 412 is effective to register a test-taker. The means by which a test-taker is registered by the membership engine 412 may be critical for certain implementations of various embodiments, but is not critical for an understanding of the system 400. Accordingly, the membership engine 412 is not described other than to mention that the membership engine 412 interacts 442 with the test-taker 430 and stores information about the test-taker 430, the interaction 442, and/or other data in the member database 424. In this way, the system 400 may include user profiles, at least one of which is associated with the test-taker 430.

In a non-limiting embodiment, the commerce engine 414 is effective to accept payment from the test-taker. The commerce engine 414 interacts 444 with the test-taker 430. The commerce engine 414 may access the member database 424, if necessary, and update the member database 424 when payment is received.

In an alternative embodiment, the membership engine 412 and commerce engine 414 are optional. User profiles may be entered into the member database 424 manually or without the requirement of membership. Also, payment is not necessarily collected from the test-taker 430 or collected through the interaction 444.

In a non-limiting embodiment, the testing engine 402 is effective to provide a question from the question database 420 to the test-taker 430 and accept an answer to the question from the test-taker 430. This occurs in the interaction designated 446 in the example of FIG. 4. The testing engine may or may not include a test rendering engine (not shown) effective to render a test interface for the test-taker 430.

A question may or may not be associated with a question characteristic. By way of example but not limitation, the question may be associated with an area of law, such as tort, a state, such as California, a country, such as the United States, or a combination of one or more question characteristics.

A user profile in the member database 424 that is associated with the test-taker 430 may also be associated with one or more question characteristics. By way of example but not limitation, the test-taker 430 may have indicated that in a current session, the test-taker 430 is interested in answering only questions that are associated with, for instance, “contract” question characteristics. Alternatively, the test-taker 430 may have indicated that all sessions should be associated with California law. In this case, only those questions having a “California law” question characteristic would be provided to the test-taker 430.

In a non-limiting embodiment, the interaction 446 may be initiated by the test-taker 430 requesting a question from the testing engine 402. Alternatively, the test-taker 430 may request a series of questions that are fed to the test-taker 430 over a period of time. Alternatively, the testing engine 402 may send questions to the test-taker 430 according to a schedule or decision-making algorithm. Questions may or may not be sent in batches that correspond to a practice test or to a section of a practice test.

In a non-limiting embodiment, the testing engine 402 may or may not include a randomizing engine (not shown) for randomly providing from the question database 420 questions associated with a question characteristic to the test-taker 430, wherein the test-taker 430 is associated with the question characteristic. For example, the testing engine 402 may send a randomly selected sequence of questions to the test-taker 430, where each of the questions and the test-taker 430 are all associated with a “California law” question characteristic. As used herein, “random” may or may not mean “pseudo-random.” Moreover, a weighted randomization may be used to attempt to focus on certain question characteristics.

By way of example but not limitation, it may be that Constitutional Law questions are more frequently asked on the California bar exam than Criminal Law questions. Accordingly, Constitutional Law questions may have greater weight (e.g., be asked more frequently on average) than Criminal Law questions.

As another example, the test-taker 430 may indicate an interest in focusing on a problem section. In this example, the test-taker 430 may be associated with both Constitutional Law questions and Criminal Law questions, but due to an interest in practicing Criminal Law, the test-taker is more heavily weighted toward Criminal Law questions. Thus, the test-taker 430 can be preferentially associated with one question characteristic over another.

As another example, it may be determined by a performance metric that the test-taker 430 has more difficulty with Criminal Law questions than Constitutional Law questions. The testing engine 402 may decide, with or without input from the test-taker 430, that the test-taker should practice Criminal Law and weight questions having the Criminal Law characteristic more heavily.

As another example, it may be determined that a statistical analysis of prior tests indicates one question characteristic is more likely to be tested than another question characteristic. In this case, the testing engine 402 may give greater weight to questions having the predicted characteristic.

Any of these various examples could be set in the user profile (e.g., a request to be tested more heavily in areas that give the test-taker 430 problems, or a request to trust the prediction that one question characteristic is more likely to be tested than another and to weight accordingly). In a non-limiting embodiment, the test-taker 430 could opt out or opt in to any of these weighted randomizations, or make requests that are not random at all.

When the test-taker 430 has submitted an answer to a question, the answer is stored in the answer database 422. In an alternative embodiment, the answer is sent directly to a grader and is not stored in the answer database 422.

In a non-limiting embodiment, the grading engine 404 is effective to provide the answer to the grader 432, provide a scorecard having a plurality of objective valuation categories represented thereon, and receive the marked-up scorecard from the grader 432 after the grader 432 marks up the scorecard based upon an objective evaluation of the answer. This occurs in the interaction designated 448 in the example of FIG. 4. The grading engine 404 may or may not be further effective to render a grading interface for the grader 432. For illustrative purposes, graded answers are stored in the answer database 422, though in non-limiting embodiments, the graded answers could be stored in a graded answer database (not shown).

In a non-limiting embodiment, the scorecard may be stored in the question database 420. The test-taker 430 may receive a subset of the data available in the question database 420 (e.g., the question itself), while the grader 432 may have access to more (e.g., the question itself, plus the scorecard associated with the question).

In a non-limiting embodiment, the scorecard includes multiple objective valuation categories, such as “issue,” “rule,” “analysis,” and “conclusion.” In another non-limiting embodiment, each of the objective valuation categories has multiple instances associated with aspects of a question. By way of example but not limitation, a question may include 7 issues, and 7 associated rules, analyses and conclusions. Each of these 7 items may be referred to as an instance of its associated objective valuation category.

In a non-limiting embodiment, in addition to the objective valuation categories, a scorecard may include one or more subjective valuation categories. By way of example but not limitation, the grader 432 may have an opportunity to score such subjective valuation categories as “organization,” “technique,” and “conciseness.” The subjective valuation categories may or may not be weighted as heavily as the objective valuation categories.

In a non-limiting embodiment, the performance metric engine 406 is effective to calculate statistics associated with the answer and the objective valuation categories. When the scorecards have been stored in the answer database 422, the performance metric engine 406 can access them to calculate these statistics. The statistics, which may be used to objectively estimate performance with respect to the answer by the test taker, may be stored in the statistics database 426.

In a non-limiting embodiment, at least some of the statistics are associated with how many instances of an objective valuation category are represented in the answer. The statistics may be categorized by test-taker 430, question characteristic, grader 432, or in any other matter as would be apparent to a person of skill in statistics with this reference before them.

In a non-limiting embodiment, the statistics in the statistics database 426 are accessed by the recommendation engine 408 to provide feedback to the test-taker 430 through interaction 450. The recommendation engine 408 is effective to provide recommendations to the test-taker 430 based on the statistics.

By way of example but not limitation, the recommendation engine 408 may provide a chart of performance with questions having a given question characteristic over time. In a non-limiting embodiment, the recommendation engine 408 uses Bayesian techniques to generate recommendations. In this example, the test-taker 430 may have access to charts for “Constitutional Law” questions that show the proportion of instances of “issue” objective valuation category the test-taker 430 gets, and improvement over time, and the proportion compared to “Contract Law,” for example. These statistics may prove to be quite valuable to the test-taker 430 to show what areas should be practiced more heavily or to spot weaknesses with respect to certain objective valuation categories (e.g., the test-taker 430 might be able to spot issues and recall rules, but forgets to perform any analysis).

In a non-limiting embodiment, the administration engine 410 is effective to facilitate adding new test questions to the question database 420, editing questions in the question database 420, deleting questions in the question database 420, and associating questions in the question database 420 with one or more question characteristics. The administrator 434 can perform these functions in an interaction 452. The administrator 434 may be granted as much or as little control over the question database 420 as is desired. In a non-limiting embodiment, some or all of the functions attributed to the administration engine 410 may be automated.

Advantageously, the administrative engine 410 includes a data model that shows the normalized relationship between “topics”, “questions”, “sections”, and “issues”. In a non-limiting embodiment, this normalized relationship underlies much of the actual code and SQL that is used in a specific embodiment.

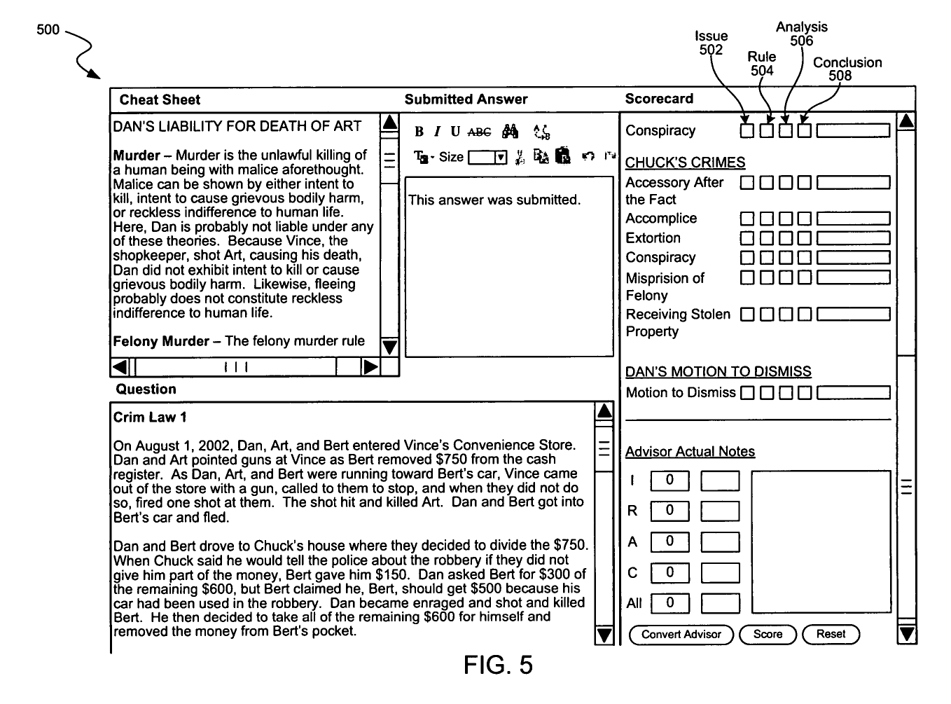

FIG. 5 depicts a screenshot 500 of a grading environment that may be rendered for a grader or administrator by, by way of example but not limitation, a grading engine. In the example of FIG. 5, the grading environment includes four checkboxes for each topic: issue checkbox 502, rule checkbox 504, analysis checkbox 506, and conclusion checkbox 508. In this example, a grader checks the checkbox to the right of a topic if the answer includes the indicated item. For example, if a topic is conspiracy and the answer includes the issue of conspiracy and the rule of conspiracy, but not analysis or conclusion, then the grader would check the issue checkbox 502 and rule checkbox 504 to the right of the conspiracy topic, but would leave the analysis checkbox 506 and the conclusion checkbox 508 unchecked. The number of checks may then be tallied and scored according to a scoring algorithm.

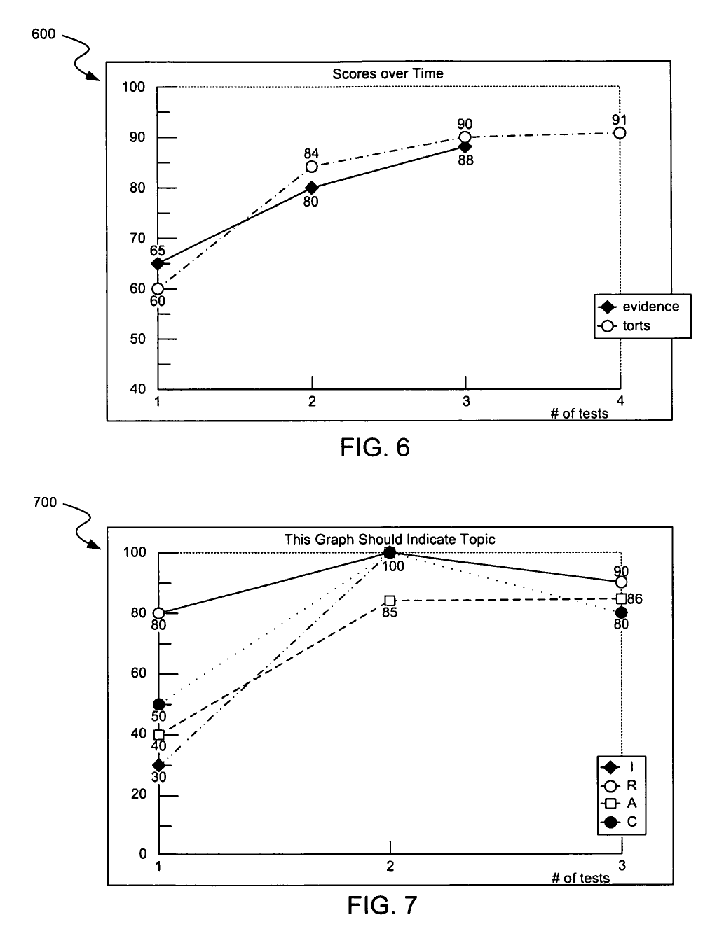

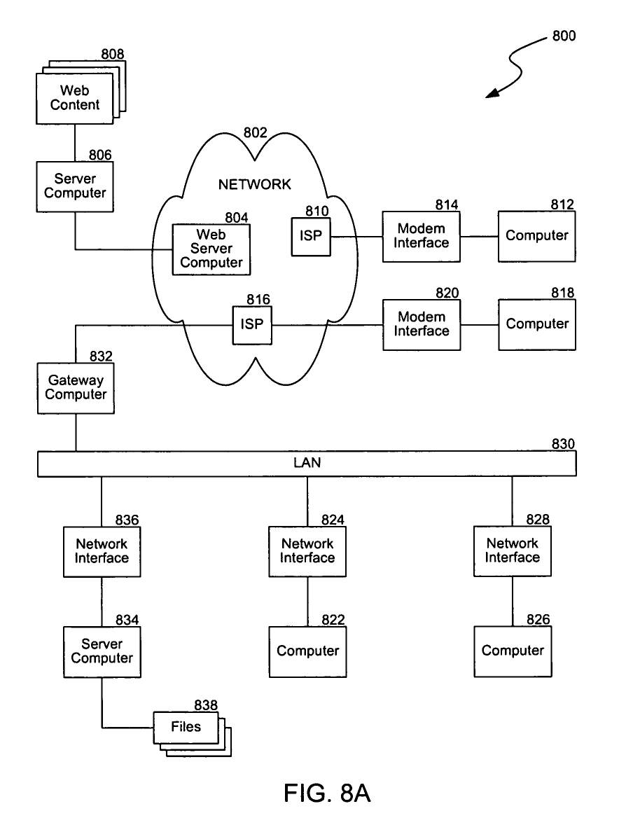

FIGS. 6 and 7 depict examples of charts 600, 700 that may be generated using the statistics derived from graded answers. In the example of FIG. 6, the chart 600 shows scores over time for two types of questions (evidence questions and torts questions). In the example of FIG. 7, the chart 700 shows scores over time for IRAC scores (which may or may not be IRAC scores for all types of questions, or for a subset of types of questions).

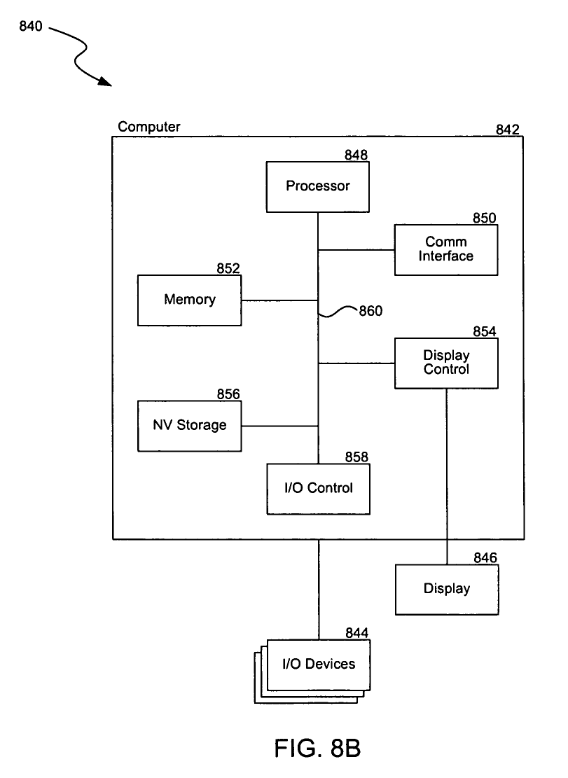

FIGS. 8A and 8B depict a conceptual view of a system on which, by way of example but not limitation, one or more of the described embodiments may be implemented. The following description of FIGS. 8A and 8B is intended to provide an overview of computer hardware and other operating components suitable for performing the methods of embodiments described herein, but is not intended to limit the applicable environments. Similarly, the computer hardware and other operating components may be suitable as part of the apparatuses of embodiments described herein. Other embodiments can be practiced with other computer system configurations, including hand-held devices, multiprocessor systems, microprocessor-based or programmable consumer electronics, network PCs, minicomputers, mainframe computers, and the like. Other embodiments can also be practiced in distributed computing environments where tasks are performed by remote processing devices that are linked through a communications network.

FIG. 8A depicts a networked system 800 that includes several computer systems coupled together through a network 802, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server computer 804 is typically at least one computer system which operates as a server computer system and is configured to operate with the protocols of the World Wide Web and is coupled to the Internet. The web server computer 804 can be a conventional server computer system. Optionally, the web server computer 804 can be part of an ISP which provides access to the Internet for client systems. The web server computer 804 is shown coupled to the server computer 806 which itself is coupled to web content 808, which can be considered a form of a media database. While two computers 804 and 806 are shown in FIG. 8A, the web server computer 804 and the server computer 806 can be one computer system having different software components providing the web server functionality and the server functionality provided by the server computer 806, which will be described further below.

Access to the network 802 is typically provided by Internet service providers (ISPs), such as the ISPs 810 and 816. Users on client systems, such as client computer systems 812, 818, 822, and 826 obtain access to the Internet through the ISPs 810 and 816. Access to the Internet allows users of the client computer systems to exchange information, receive and send e-mails, and view documents, such as documents which have been prepared in the HTML format. These documents are often provided by web servers, such as web server 804, which are referred to as being “on” the Internet. Often these web servers are provided by the ISPs, such as ISP 810, although a computer system can be set up and connected to the Internet without that system also being an ISP.

Client computer systems 812, 818, 822, and 826 can each, with the appropriate web browsing software, view HTML pages provided by the web server 804. The ISP 810 provides Internet connectivity to the client computer system 812 through the modem interface 814, which can be considered part of the client computer system 812. The client computer system can be a personal computer system, a network computer, a web TV system, or other computer system. While FIG. 8A shows the modem interface 814 generically as a “modem,” the interface can be an analog modem, ISDN modem, cable modem, satellite transmission interface (e.g. “direct PC”), or other interface for coupling a computer system to other computer systems.

Similar to the ISP 814, the ISP 816 provides Internet connectivity for client systems 818, 822, and 826, although as shown in FIG. 8A, the connections are not the same for these three computer systems. Client computer system 818 is coupled through a modem interface 820 while client computer systems 822 and 826 are part of a LAN 830.

Client computer systems 822 and 826 are coupled to the LAN 830 through network interfaces 824 and 828, which can be Ethernet network or other network interfaces. The LAN 830 is also coupled to a gateway computer system 832 which can provide firewall and other Internet-related services for the local area network. This gateway computer system 832 is coupled to the ISP 816 to provide Internet connectivity to the client computer systems 822 and 826. The gateway computer system 832 can be a conventional server computer system.

Alternatively, a server computer system 834 can be directly coupled to the LAN 830 through a network interface 836 to provide files 838 and other services to the clients 822 and 826, without the need to connect to the Internet through the gateway system 832.

FIG. 8B depicts a computer system 840 for use in the system 800 (FIG. 8A). The computer system 840 may be a conventional computer system that can be used as a client computer system or a server computer system or as a web server computer system. Such a computer system can be used to perform many of the functions of an Internet service provider, such as ISP 810 (FIG. 8A). The computer system 840 includes a computer 842, I/O devices 844, and a display device 846. The computer 842 includes a processor 848, a communications interface 850, memory 852, display controller 854, non-volatile storage 856, and I/O controller 858. The computer system 840 may be couple to or include the I/O devices 844 and display device 846.

The computer 842 interfaces to external systems through the communications interface 850, which may include a modem or network interface. It will be appreciated that the communications interface 850 can be considered to be part of the computer system 840 or a part of the computer 842. The communications interface can be an analog modem, isdn modem, cable modem, token ring interface, satellite transmission interface (e.g. “direct PC”), or other interfaces for coupling a computer system to other computer systems.

The processor 848 may be, for example, a conventional microprocessor such as an Intel Pentium microprocessor or Motorola power PC microprocessor. The memory 852 is coupled to the processor 848 by a bus 860. The memory 852 can be dynamic random access memory (DRAM) and can also include static ram (SRAM). The bus 860 couples the processor 848 to the memory 852, also to the non-volatile storage 856, to the display controller 854, and to the I/O controller 858.

The I/O devices 844 can include a keyboard, disk drives, printers, a scanner, and other input and output devices, including a mouse or other pointing device. The display controller 854 may control in the conventional manner a display on the display device 846, which can be, for example, a cathode ray tube (CRT) or liquid crystal display (LCD). The display controller 854 and the I/O controller 858 can be implemented with conventional well known technology.

The non-volatile storage 856 is often a magnetic hard disk, an optical disk, or another form of storage for large amounts of data. Some of this data is often written, by a direct memory access process, into memory 852 during execution of software in the computer 842. One of skill in the art will immediately recognize that the terms “machine-readable medium” or “computer-readable medium” includes any type of storage device that is accessible by the processor 848 and also encompasses a carrier wave that encodes a data signal.

The computer system 840 is one example of many possible computer systems which have different architectures. For example, personal computers based on an Intel microprocessor often have multiple buses, one of which can be an I/O bus for the peripherals and one that directly connects the processor 848 and the memory 852 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 852 for execution by the processor 848. A Web TV system, which is known in the art, is also considered to be a computer system according to the present invention, but it may lack some of the features shown in FIG. 8B, such as certain input or output devices. A typical computer system will usually include at least a processor, memory, and a bus coupling the memory to the processor.

In addition, the computer system 840 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 856 and causes the processor 848 to execute the various acts required by the operating system to input and output data and to store data in memory, including storing files on the non-volatile storage 856.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description provided herein. In addition, the present invention is not described with reference to any particular programming language, and various embodiments may thus be implemented using a variety of programming languages.

As used herein, the term “embodiment” means an embodiment that serves to illustrate by way of example but not limitation. As used herein, the term “alternative” is used to describe an embodiment that is not equivalent to another embodiment.

While a number of exemplary aspects and embodiments have been discussed above, those of skill in the art will recognize certain modifications, permutations, additions, and sub-combinations thereof. It is therefore intended that any claims hereafter introduced based upon these descriptions and drawings are interpreted to include all such modifications, permutations, additions, and sub-combinations as are within their true spirit and scope.

What is claimed is:

1. A method comprising:
providing a question to an on-line tester;
starting a print timer;
allowing the on-line tester to print the question if the print timer has not expired;
starting a test timer;
allowing the on-line tester to submit an answer to the question if the test timer has not expired;
sending the answer to an on-line grader.

2. The method of claim 1, further comprising allowing the on-line tester to submit the answer before the test timer expires.

3. The method of claim 1, wherein said sending the answer to an on-line grader includes sending the answer to an on-line grader site, wherein the on-line grader site includes a means for providing the question to an on-line grader.

4. The method of claim 1, further comprising:
providing an ungraded exam from a database of ungraded exams to one of a plurality of on-line graders;
displaying for the on-line grader an answer to a question of the ungraded exam;
displaying for the on-line grader a scorecard associated with the question;
allowing the on-line grader to mark up the scorecard;
sending the marked up scorecard to an on-line tester associated with the answer.

5. The method of claim 4, further comprising displaying data that is objectively helpful in analyzing merits of the answer.

6. The method of claim 4, wherein said displaying for the online grader a scorecard associated with the question further comprises:
listing a plurality of items associated with the question; and
listing a plurality of category selectors for each of the items, wherein the category selectors are selectable by the on-line grader to indicate that an issue was identified in the answer.

7. The method of claim 4, wherein said displaying for the online grader a scorecard associated with the question further comprises: including a plurality of checkboxes for each of a plurality of items associated with the question, wherein each item includes at least four checkboxes associated with whether the answer includes identification of an issue associated with the item, identification of a rule applicable to the item; analysis of facts using the rule; and a conclusion.

8. A method comprising:
weighting a plurality of objective valuation categories relative to one another according to estimated values for each of the objective valuation categories;
receiving a grader scorecard having the plurality of objective valuation categories represented thereon, wherein the grader scorecard has been marked up according to an objective evaluation of an answer to a test question;
calculating, using the marked-up scorecard, statistics associated with the answer and one or more of the objective valuation categories;
presenting a performance metric that incorporates the statistics.

9. The method of claim 8, wherein the objective valuation categories include an issue valuation category, a rule valuation category, an analysis valuation category, and a conclusion valuation category.

10. The method of claim 8, wherein the scorecard further includes one or more subjective valuation categories, and wherein the subjective valuation categories are marked up according to a subjective evaluation of the answer.

11. The method of claim 8 wherein an objective valuation category of the objective valuation categories includes a plurality of instances, and wherein each of the plurality of instances is represented on the scorecard.

12. A system comprising:
a question database having a plurality of questions for provisioning to potential test takers;
a testing engine effective to provide a question of the one or more questions to a test-taker, and accept an answer to the question from the test-taker;
a grading engine effective to provide the answer to a grader, provide a scorecard having a plurality of objective valuation categories represented thereon, and receive the marked-up scorecard from the grader after the grader marks up the scorecard based upon an objective evaluation of the answer;
a performance metric engine effective to calculate statistics associated with the answer and the objective valuation categories, wherein the statistics are effective to objectively estimate performance with respect to the answer by the test taker.

13. The system of claim 12, further comprising:
a membership engine effective to register the test taker;
a member database having a plurality of user profiles stored therein, wherein at least one of said user profiles is associated with the test-taker;
a commerce engine effective to accept payment from the test-taker.

14. The system of claim 12 wherein the questions in the question database are associated with a question characteristic, and wherein the user profile associated with the test-taker is associated with one or more of the question characteristics, wherein the testing engine includes a randomizing engine for randomly providing from the question database questions associated with a question characteristic to a test-taker that is associated with the question characteristic.

15. The system of claim 12, further comprising:
an administration engine effective to facilitate adding new test questions to the question database, editing questions in the question database, deleting questions in the question database, and associating questions in the question database with one or more question characteristics.

16. The system of claim 12, further comprising an answer database, wherein the testing engine is further effective to store the answer in the answer database, and wherein the grading engine is further effective to provide the answer from the answer database to the grader.

17. The system of claim 12, wherein the grading engine is further effective to store a graded answer associated with the objective evaluation by the grader of the answer in the answer database, and wherein the performance metric engine is further effective to access the graded answer in the answer database and calculate statistics associated with the graded answer and the objective valuation categories.

18. The system of claim 12, further comprising a statistics database, wherein the performance metric engine is further effective to store the statistics associated with the answer and the objective valuation categories, and wherein the recommendation engine is further effective to answer the statistics to provide the recommendations to the test-taker.

19. The system of claim 12 wherein an objective valuation category of the objective valuation categories includes a plurality of instances associated with a respective plurality of aspects of the question, and wherein at least some of the statistics are associated with how many of the instances are represented in the answer.

20. The system of claim 12, further comprising a recommendation engine effective to provide recommendations to the test-taker based on the statistics.
